(19) United States
(12) Patent Application Publication
(10) Pub. No.: US 2025/0339758 A1
(43) Pub. Date: Nov. 6, 2025

(54) Low-profile suspension device for skates, skateboards, and the like.

(71) Applicants: Mark Williams, Sidney, MI (US); Melanie Osterman, Lansing, MI (US)

(72) Inventors: Mark Williams, Sidney, MI (US); Melanie Osterman, Lansing, MI (US)

(21) Appl. No.: 19/199,142

(22) Filed: May 5, 2025

Related U.S. Application Data
(60) Provisional application No. 63/642,814, filed on May 5, 2024.

(51) Int. Cl. A63C 17/00; A63C 17/04; B62B 5/00

(52) U.S. Cl. CPC A63C 17/0046; A63C 17/014; A63C 2203/20; B62B 5/00; B62B 2202/30

(57) ABSTRACT

A suspension system for skateboards that provides a low profile, high strength suspension system to support a typical roller skate which incorporates one independent and/or offset style suspension and one offset style suspension which includes a flat plate next to a cover with apertures; two support posts secured and configured perpendicularly to the flat plate, where each post has either a drive stud at one end and an aperture and bearing at an opposite end to the flat plate and drive stud; a torsion arm with a socket to connect to the drive stud; and a hub base that encircles the torsion arm opposite the socket which secures the hub base to the torsion arm while the hub base is removably secured to a stub shaft; a way to attach the flat plate and a second way for removably connecting the cover to the skate base plate.

### CROSS REFERENCE TO RELATED APPLICATIONS

This application claims the benefit of United States Provisional Patent Application with Ser. No. 63/642,814 filed May 5, 2024, by Mark Williams and Melanie Osterman. The application is entitled “A low-profile suspension device for skates, skateboards, and the like.”

A low-profile suspension system for skates, skateboards, and the like.

### FIELD OF INVENTION

This invention relates to a low-profile suspension system for skates, skateboards, roller skis and the like. The present invention relates to roller skates and skateboards with brakes, e.g., toe stoppers, and roller skis. This invention relates to the field of roller skates and, particularly, to an improved skate with a low-profile suspension system. This relates to the general field of sporting equipment, and more specifically toward roller skates and skateboard wheel assemblies with an integrated combination of components to achieve a lower center of gravity for the suspension system. The present invention generally relates to a suspension system for inline skates, and more specifically, to a suspension system that incorporates a flexible beam or torsion arm to absorb shock and thereby increase the comfort to those skating over rough terrain. The present invention relates to in-line roller skates and more particularly to an adaptive wheel suspension system and torsion arm that permits the wheels of the skates to deflect independently in the vertical plane. This achieves a lower center of gravity and a set of individual wheel suspension for independently absorbing shocks from uneven terrain.

### SEARCH

None.

### SEQUENCE LISTING OR PROGRAM

None.

### BACKGROUND—FIELD OF INVENTION and PRIOR ART

There are no other low-profile suspension devices for skates, skateboards, and the like. A variety of designs for roller skates have been developed over the years. Roller skates are shoes or bindings that fit onto shoes that are worn to enable the wearer to roll along on wheels. The first roller skate was an inline skate design, effectively an ice skate with wheels replacing the blade. Later the “quad skate” style became more popular, consisting of four wheels arranged in the same configuration as a typical car. Roller skating is a hobby, sport, and mode of transportation using roller skates.

While the first reported use of wheeled skates was on a London stage in 1743, the first patented “roller skate” was introduced in 1760 by Belgian inventor John Joseph Merlin. They were harder to steer and stopping was difficult because they did not have any type of braking mechanism and as such, they failed to gain popularity. Merlin demonstrated his invention during a party in the city of Huy, during which he skated while playing the violin. In the 1840s, Meyerbeer's opera Le prophète featured a scene in which performers used roller-skates to simulate ice-skating on a frozen lake set on stage. This exposure had an impact on audiences and led to the rise of roller skating as a new and popular activity throughout the Continent. As ice skaters subsequently developed the art of figure skating, roller skaters wanted the ability to turn in their skates in a similar fashion. In 1863, James Plimpton from Massachusetts invented the “rocking” skate and used a four-wheel configuration for stability, and independent axles that turned by pressing to one side of the skate or the other when the skater wants to create an edge. This was a vast improvement on the Merlin design, one that was easier to use and drove the huge popularity of roller skating, dubbed “rink-o-mania” in the 1860s and 1870s, which spread to Europe and around the world, and continued through the 1930s. The Plimpton skate is still used today. Eventually, roller skating evolved from just a pastime to a competitive sport; speed skating, racing on skates, and inline figure skating, very similar to what can be seen in the Olympics on ice. In the mid-1990s roller hockey, played with a ball rather than a puck, became so popular that it even made an appearance in the Olympics in 1992. The National Sporting Goods Association statistics showed, from a 1999 study, that 2.5 million people played roller hockey. Roller skating was considered for the 2012 Summer Olympics but has never become an Olympic event. Other roller-skating sports include jam skating and roller derby.

Roller skating popularity began during the late 1950s and 1960s at rock ‘n’ roll teen dance halls but exploded and took off in the disco and new wave era of the 1970s and 1980s, becoming popular and an iconic thing of that time. In the early 1990s it would begin to diminish in popularity. Sales of roller skates increased during the COVID-19 pandemic as people sought safe outdoor activities. Roller skating saw a revival in the late 2010s and early 2020s, spurred on by a number of viral videos on the popular video-sharing app TikTok and also a revival of 1970s and 1980s pop culture from film and TV nostalgia. Many popular brands sold out to the point of backorder, with many people taking up the hobby during COVID-19 quarantines across the globe.

The sport of skateboarding can trace its root to the 1940's, although it became a popular sport beginning in the 1960's as an offshoot of surfing. Because skateboards can be used anywhere, there are hard surfaces, such as streets and sidewalks, and are not limited to coastal areas with decent surfacing conditions, it has eclipsed the popularity of surfing several times over both in terms of numbers of participants and size of the industry. As would be expected with such a developed sport, skateboards and their components have evolved over four decades or so since the first person took the wheels off an old pair of roller skates and put them on the underside of a 2″×4″ piece of wood. The modern skateboard comprises several basic components, including a riding surface, or deck, usually made of an elongated piece of wood, fiberglass or some other sturdy, resilient and flexible material, four wheels with some sort of ball bearing arrangement upon which the deck and rider are transported, and two skateboard trucks, where the trucks are the steering mechanisms or devices by which the wheels are connected to the deck. The trucks are attached to the deck in a mirror image manner, such that as the user leans on one side of the skateboard, the forces applied by the user cause each truck to simultaneously steer in the opposite direction that the other truck steers. While located in a fairly unobtrusive location on the underside of the deck, the trucks are very important as they determine how the skater controls his/her skateboard by determining how a skateboard's wheels turn. A person doubting the importance of the trucks merely needs to try a quick straight-line trip down a winding hill on a skateboard with trucks that do not allow the skateboard wheels to turn before realizing the folly of such an opinion.

Skateboard trucks are made in a wide variety of styles which rely upon several basic components, within which there can be significant variation. The basic components of the modern skateboard truck include a base plate or a truck mounting plate, which is a molded piece of metal with at least four holes along its edges, which is used to screw or bolt the truck to the bottom of the deck, a bolt, which attaches the wheel-mounting axle to the base plate, and an upward-projecting, wheel-mounting axle which suspends the skateboard wheels on either side of the kingpin and has a single truck axle or kingpin which sits in a protected cup or pin-receiving hole in the base plate. The turning ability of the skateboard depends on the design and adjustments made to the kingpin, as the wheels of the skateboard traditionally pivot around or near the kingpin. The bolt is generally threaded through an oversized hole lined with compressible and resilient bushings, often made of plastic components such as urethane, whereby tightening the bolt makes it more difficult to flex the axle, and therefore more difficult to turn the skateboard (tightening the bolt also generally tends to make the skateboard more stable and less susceptible to “wobble” at high speeds, so there is an inherent trade-off between a user's desire for skateboard maneuverability and stability at high speeds).

As the user leans from side to side, the bolt presses against the bushings, enabling turning and at the same time compressing the bushings, such that further leaning becomes more and more difficult for the user. The skateboard user steers the skateboard by leaning from one side to another, thereby applying pressure to the truck, such that the truck pivots around the truck axles whereby on the front wheels, the outer wheel moves forward while the inside wheel moves back, and on the rear wheels, the outer wheel moves back and the inner wheel moves forward, thereby causing the two sets of wheels to no longer be in alignment but rather to describe an arc through which the skateboard will now travel, presuming the rider balances successfully on the skateboard. As with many action sports, skateboarders are always looking for ways to improve upon their equipment by borrowing technologies or ideas from other sports. Having its origin in surfing (indeed, skateboarding initially was nicknamed “sidewalk surfing”), skateboarding borrowed heavily from surfing in its early days.

### Problems Solved

Many problems and shortfall in roller skates and skateboards are solved with the advent of a low-profile suspension device for skates, skateboards, and the like. The advantages include (a) providing a low-profile solution for suspending the wheel; (b) reducing the number of components for the suspension system; (c) providing a variety of cross sections used for the torsion arm; (d) requiring only simple tools to originally attach the suspension system to the skate, skateboard, skis or to install on aftermarket, existing skates, skis, etc.; (e) lowering the center of gravity for the roller skate; and (f) using common components and materials in a unique combination to achieve the low-profile configuration of the suspension device.

### PRIOR ART

A novelty search was completed for a low-profile suspension device for skates, skateboards, and the like. It revealed the following:
A. U.S. Pat. No. 5,224,719 by Bryon L. Goodspeed in 1993 for a Skateboard. This is a skateboard having a deck; a frame mounted under the deck; a pedal pivotally mounted to the frame substantially below the deck and adjacent a forward portion of the deck; a plurality of wheels and clutch bearing retaining drive wheels rotatably mounted to substantially conventional diagonal axis steering trucks on the underside of the deck; a block having grooves therein and mounted underneath the deck; transmission member comprising a rack with two members having upwardly facing portions slidable within the grooves in the block and downwardly facing toothed portions for driving pinions rotatably mounted to the frame, the pinions driving pulleys having clutch bearings therein and also rotatably mounted to the frame, the pulleys being operably connected to drive wheels by loops of flexible belt material of circular cross section on either side of steering axes such that depression of the pedal reciprocates the rack members via a roller engagement between the rack and the pedal to impart rotational motion to the drive wheels; and spring return member for biasing the rack and the pedal toward their ready positions when the pedal is not depressed. In a second embodiment, a modified transmission member is provided wherein a similar rack is reciprocal along a system of rollers and is linked to a cammed surface to provide variable speed output over the range of pedal depression.
B. U.S. Pat. No. 6,273,437 by Lovitt et al., in 2001 for Roller Skates. Here is demonstrated a two-wheeled roller skate with canted wheels that have an axle for the forward wheel located well forward of the ball of the foot. The axle for the rear wheel is located at the rear of the skater's heel. The wheels are canted so that the front and rear wheels contact the ground on the opposite sides of the center line of the skater's foot. In plan projection, the axles are preferably non-parallel in order to provide steering correction. The amount of steering correction desirable will depend on the skater's skill and the nature of the skating activity. In alternative embodiments, the present invention incorporates novel braking mechanisms.
C. U.S. Pat. No. 8,720,916 by Bermal in 2014 for Skateboard Truck. Provided in this patent is a skateboard truck assembly with an integrated combination of a system of gears that resemble planetary gears that allow both wheels and a caster to remain on the ground while the skateboard is traveling in a lengthwise manner. At the same time, when the rider leans to one side or the other of the skateboard, the gear assembly causes the “downhill” wheel to rise in the air and the caster to be displaced such that the skateboarder can laterally “slide” or “drift” the skateboard as though it was a snowboard. Because the downhill wheel is raised well above the ground, there is less of a tendency for the downhill wheel to catch on any street irregularities or rocks and stop sliding at inopportune times.
D. U.S. Pat. No. 11,446,562 by Desberg in 2022 for Caster Boards with Removable Insert. This demonstrates a caster board can include a front platform, a rear platform, and at least two neck sections extending between the front platform and the rear platform. The neck sections can serve as a torsion element allowing twisting of the front platform relative to the rear platform. An aperture between the neck sections can be configured to receive an insert. The insert can alter a structural characteristic of the caster board, such as the torsional stiffness of the caster board.
E. U.S. patent application No. 20130175777 by Bermal in 2013 for Skateboard Truck. Shown in this application is a skateboard truck assembly with an integrated combination of a system of gears that resemble planetary gears that allow both wheels and a caster to remain on the ground while the skateboard is traveling in a lengthwise manner. At the same time, when the rider leans to one side or the other of the skateboard, the gear assembly causes the “downhill” wheel to rise in the air and the caster to be displaced such that the skateboarder can laterally “slide” or “drift” the skateboard as though it was a snowboard. Because the downhill wheel is raised well above the ground, there is less of a tendency for the downhill wheel to catch on any street irregularities or rocks and stop sliding at inopportune times. And,
F. U.S. patent application No. 20140312588 by Davis in 2014 for Swivel Wheel Mounting for A Scooter. This demonstrates a scooters which typically have a fixed rear wheel and a rotating front wheel on a length forming a handle. Such scooters are not always able to be used to perform tricks and stunts because they have a fixed rear wheel that can inhibit this. In particular many children and adults wish to drift the rear wheel or have it at oblique angle to the scooter's direction of movement. The present invention provides a scooter wheel mounting capable of forming in use a two wheeled scooter, wherein the rear wheel being provided on a rotatable seat.

As one can observe, none of the prior art has anticipated nor caused one skilled in the systems and devices of roller skates and “roller-balled” skateboards. The low-profile suspension device for skates, skateboards, and the like lessens or completely avoids all the problems mentioned above as well as the advantages listed below in an efficient manner.

### SUMMARY OF THE INVENTION

This invention is a low-profile suspension device for skates, skateboards, and the like. The preferred embodiment of the low-profile suspension device for skates, skateboards, and the like is: a low profile, high strength suspension system to support a typical roller skate comprising (a) at least one independent style suspension and/or an offset style suspension wherein the suspension system comprises: (1) a flat plate contiguous to a cover with apertures; (2) at least two support posts center, offset post, and/or support post, each post being fixedly secured at a flat plate end and configured essentially perpendicular to the flat plate and each post with either a drive stud at one end and an aperture and bearing at an end opposite the flat plate and the drive stud; (3) torsion arm with a standard or metric socket at one end to removably connect to the drive stud; and (4) a hub base with at least one aperture to encircle the torsion arm at the end opposite the socket and set screws to secure the hub base to the torsion arm, and the hub base removably secured to a stub shaft; and (b) a means to attach the flat plate of the low profile, high strength suspension system to a skate base plate of the typical roller skate; (c) the cover with apertures; and (d) a means for removably connecting cover to skate base plate.

### OBJECTS AND ADVANTAGES

There are several objects and advantages of a low-profile suspension device for skates, skateboards, and the like. These various advantages and benefits include:

| Item | Advantages |
|---|---|
| 1 | Provides a low-profile solution for suspending the |
| | wheel |
| 2 | Reduces number of components for the suspension system |
| 3 | Provides a variety of cross sections used for the torsion arm |
| 4 | Requires only simple tools to originally attach the |
| | suspension system for the skate, skateboard, skis or |
| | to install on aftermarket, existing skates, skis, etc. |
| 5 | Lowers the center of gravity for the roller skate |
| 6 | Uses common components and materials in a unique |
| | combination to achieve the low-profile configuration |
| | of the suspension device |

Finally, other advantages and additional features of the low-profile suspension device for skates, skateboards, and the like will be more apparent from the accompanying drawings and from the full description of the device. For one skilled in the art of roller skates and skateboards it is readily understood that the features shown in the examples with this product can be adapted to other types of roller devices to achieve a lower profile and center of gravity.

### DESCRIPTION OF THE DRAWINGS—FIGURES

The accompanying drawings, which are incorporated in and constitute a part of this specification, illustrate an embodiment of a low-profile suspension device for skates, skateboards, and the like. The drawings together with the summary description given above and a detailed description given below help to explain the principles of the A low-profile suspension device for skates, skateboards, and the like. It is understood, however, that this low-profile suspension device for skates, skateboards, and the like is not limited to only the precise arrangements and instrumentalities shown.

FIGS. 1 A through 1 D are sketches of the general low profile, high strength suspension system for skates, ski systems, and other low-profile suspensions.

FIGS. 2 A through 2 C are sketches of the general offset and independent style suspension from a heel view and a bottom view with auxiliary wheels, all sketches of the device with components and features noted.

FIGS. 3 A through 3 D are sketches of the hub detail from various views with the components and features shown and a set of typical skates that can benefit from the low-profile suspension system from generally a side view.

FIGS. 4 A through 4 C are sketches of the Offset type of suspension from the bottom and a rear view with components and features noted and for example cross sections for the shaft.

FIGS. 5 A through 5 D are drawings for the low profile, high strength suspension system with optional variations for the device and a typical roller skate and components.

FIGS. 6 A through 6 F are sketches of prior art skates, boards, and suspension systems for comparison with the Applicant's device.

### DESCRIPTION OF THE DRAWINGS—REFERENCE NUMERALS

The following list refers to the drawings:

### Table B: Reference Numbers—

| Ref # | Description |
|---|---|
| 30 | low profile, high strength suspension system 30 |
| 32 | independent style suspension 32 |
| 34 | bottom view sketch 34 of modified and improved |
| | suspension system 30 for skates 80 and related |
| | products |
| 35 | offset style suspension 35 |
| 38 | manufacturing drawings 30 for low profile, high |
| | strength suspension system 30 |
| 39 | notes 39 on variations and uses |
| 55 | adjustable brake pad 55 |
| 56 | gripper pad 56 for soft mode |
| 60 | typical roller skate 60,80 with a boot 61, a plate |
| | 62, bearings 63, wheels 64, and a toe stop 65 |
| 61 | a boot 61 |
| 62 | a plate 62 |
| 63 | a set of bearings 63 for wheels 64 |
| 64 | a set of wheels 64 |
| 65 | a toe stop 65 |
| 70 | torsion arm 70 with defined cross-sections 70A and |
| | said torsion arm made from a variety of materials |
| | 70B-steel, steel and iron alloys, composite |
| | materials, titanium, brass, copper, polymers, |
| | plastics, reinforced plastics, and the like |
| 70A | cross sections 70A of shaft 70 such as circle |
| | 70A1, ellipse 70A2, hexagon 70A3, octagon 70A4, |
| | square 70A5, triangle 70A6, rectangle 70A7, and |
| | regular and irregular polygons |
| 72 | drive stud 72 approximately-for example and not |
| | as a limitation-⅜ inch |
| 75 | standard or metric socket 75 matched to accept/ |
| | reattach ably connected and surrounding a drive |
| | stud 72 approximately-for example and not as a |
| | limitation-⅜ inch |
| 80 | skate shoes 80-various sets and types 80A- |
| | cambers and various sizes shown, as example only |
| | and not as a limitation |
| 81 | bearing Snap-on component 81 with clip 81A on the |
| | inside to prevent removal |
| 82 | skate base plate 82 |
| 83 | bearing/bushing 83 of wheel 88 |
| 84 | bearing/bushing 84 of torsion arm 70 |
| 85 | center post 85 |
| 86 | offset post 86 |
| 87 | support post 87 |
| 88 | wheel 88 made of plastics, reinforced plastics, |
| | ceramics, metals, and the like; auxiliary wheel |
| | 80A and having a cross section like a regular- |
| | shaped wheel |
| 89 | stub shaft/wheel axel 89 or the like connected |
| | essentially in perpendicular configuration to a |
| | hub base 90 at one end and ready to connect to a |
| | bearing 83 wheel 88 at the opposite end |
| 90 | hub base 90 |
| 91 | hub base components sketch 91 |
| 92 | set screws 92 on hub base 90 |
| 92A | apertures 92A for removably connecting set screws |
| | 92 through the hub base 90 to torsion arm 70 |
| 95 | apertures 95 through posts 85,86, and/or 87 and |
| | hub base 90 for securing torsion arm 70 to the hub |
| | base 90 by means of at least one set screws 92 |
| | removably secured in the apertures 92A of the hub |
| | base 90 |
| 96 | a flat plate 96 contiguous to a cover 99 with at |
| | least two support posts 85, 86, 87 secured |
| | essentially perpendicular to flat plate 96 |
| | (welded, molded, cast or equal posts to plate 99A) |
| | and apertures for set screws 97 and 98 |
| 97 | means 97 for removably connecting cover 99 to |
| | skate base plate 82 such as screws, bolts, rivets, |
| | pins, and the like |
| 98 | means 98 for removably connecting flat plate 96 to |
| | skate base plate 82 such as screws, bolts, rivets, |
| | pins, and the like |
| 99 | cover 99 over system 30 components and removably |
| | attached through the apertures 97A to skate base |
| | plate 82 of the skate 80 |
| 105 | floor level 105 |
| 110 | adjustable brake pad 110 |
| 115 | gripper pad 115 for soft mode |
| 120 | cross-section 120 |
| 123 | material 123 for the low profile, high strength |
| | suspension system 30 |
| 700 | a prior art 700 US Patent Application US |
| | 20140312588 by Davis in 2014 for Swivel Wheel |
| | Mounting for A Scooter |
| 710 | prior art 710 US Patent US 11446562 by Desberg in |
| | 2022 for Caster Boards with Removable Insert |
| 720 | prior Art 720 US Patent Application US 20130175777 |
| | by Bermal in 2013 for Skateboard Truck |
| 730 | prior Art 730 US Patent US 8720916 by Bermal in |
| | 2014 for Skateboard Truck |
| 740 | prior Art 740 US Patent US 6273437 by Lovitt et |
| | al., in 2001 for Roller Skate |
| 750 | prior Art 750 US Patent Application US 5224719 by |
| | Bryon L. Goodspeed in 1993 for Skateboard |

### DETAILED DESCRIPTION OF PREFERRED EMBODIMENT

This invention relates to a low-profile suspension system or device for skates, skateboards, roller skis and the like. The present invention relates to roller skates and skateboards with brakes, e.g., toe stoppers, and roller skis. This invention relates to the field of roller skates and, particularly, to an improved skate with a low-profile suspension system. This relates to the general field of sporting equipment, and more specifically toward roller skates and skateboard wheel assemblies with an integrated combination of components to achieve a lower center of gravity for the suspension system. The present invention generally relates to a suspension system for inline skates, and more specifically, to a suspension system that incorporates a flexible beam or torsion arm to absorb shock and thereby increase the comfort to those skating over rough terrain. The present invention relates to in-line roller skates and more particularly to an adaptive wheel suspension system and torsion arm that permits the skate's wheels to deflect independently in the vertical plane. This achieves a lower center of gravity and a set of individual wheel suspension for independently absorbing shocks from uneven terrain.

The preferred embodiment of the low-profile suspension device for skates, skateboards, and the like is: a low profile, high strength suspension system or device 30 to support a typical roller skate 60 comprising (a) at least one independent style suspension 32 and/or an offset style suspension 35 wherein the suspension system 30 comprises: (1) a flat plate 96 contiguous to a cover 99 with apertures 97A; (2) at least two support posts center 85, offset post 86, and/or support post 87, each post being fixedly secured at a flat plate end and configured essentially perpendicular to the flat plate 96 and each post with either a drive stud 72 at one end and an aperture 95 and bearing at an end opposite the flat plate 96 and the drive stud 72; (3) torsion arm 70 with a standard or metric socket 75 at one end to removably connect to the drive stud 72; and (4) a hub base 90 with at least one apertures 95 to encircle the torsion arm 70 at the end opposite the socket 75 and set screws to secure the hub base to the torsion arm 70, and the hub base 90 removably secured to a stub shaft 89; and (b) a means 98 to attach the flat plate 96 of the low profile, high strength suspension system 30 to a skate base plate 82 of the typical roller skate 50; (c) the cover 99 with apertures 97A; and (d) a means 97 for removably connecting cover 99 to skate base plate 82.

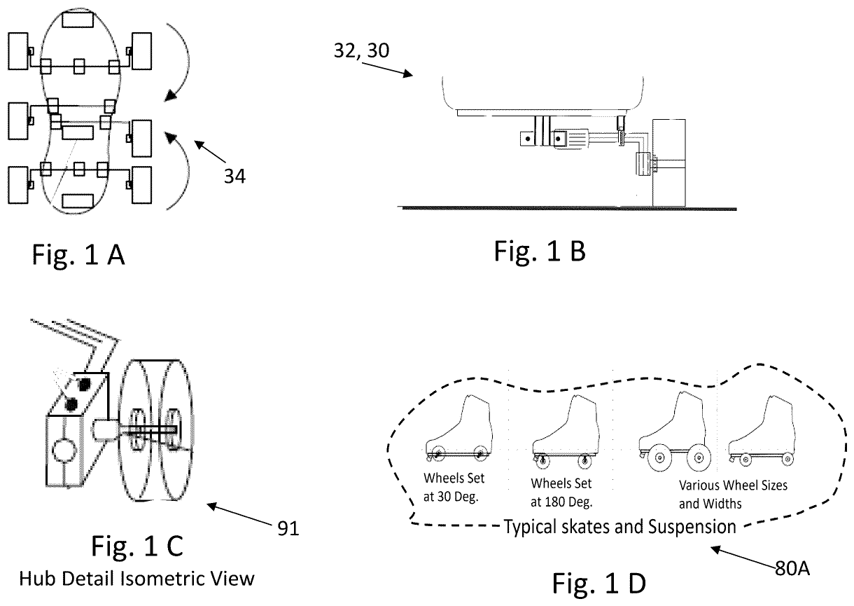

There is shown in FIGS. 1-6 a complete description and operative embodiment of a low-profile suspension device for skates, skateboards, and the like. In the drawings and illustrations, one can note well that FIGS. 1-6 demonstrate the general configuration and use of this product. The operation and use section, below, describes how it operates. The accompanying drawings, which are incorporated in and constitute a part of this specification, illustrate an embodiment of the low-profile suspension device 30 for skates, skateboards, and the like. The drawings together with the summary description given above and a detailed description given below are presented to further explain the principles of a low-profile suspension device for skates, skateboards, and the like as presented herein. It is understood, however, that this system 30 is not limited to only the precise arrangements and instrumentalities shown. Other examples for using the device and their uses are still understood by one skilled in the art of suspension systems and small wheeled devices like skates, skateboards and other self-propelled vehicles, devices, systems, and associated processes to be within the scope and spirit shown here.

FIGS. 1 A through 1 D are sketches of the general low profile, high strength suspension system 30 for skates, ski systems, and other low-profile suspensions. In this first set of drawings, one sees the overview of components as: a low profile, high strength suspension system 30; an independent style suspension 32; a bottom view sketch 34 of modified and improved suspension system 30 for skates 80 and related products; a skate shoes 80—various sets and types 80A—cambers and various sizes shown, as example only and not as a limitation; and a sketch 91 of hub base components.

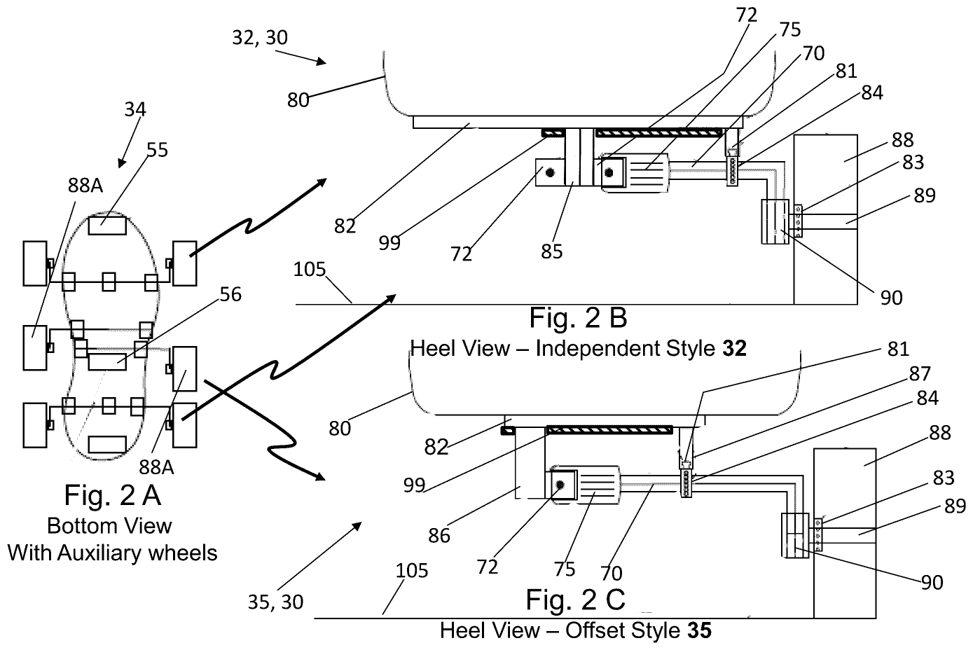

FIGS. 2 A through 2 C are sketches of the general offset 35 and independent style suspension 32 from a heel view and a bottom view with auxiliary wheels, all are sketches of the device 30 with components and features noted. Shown in these views are: a low profile, high strength suspension system 30; an independent style suspension 32; a bottom view sketch 34 of modified and improved suspension system 30 for skates 80 and related products; an offset style suspension 35; a set of manufacturing drawings 30 for low profile, high strength suspension system 30; a set of notes 39 on variations and uses; an adjustable brake pad 55; a gripper pad 56 for soft mode; a torsion arm 70 with various cross-sections 70A—and said torsion arm made of various materials 70B—steel, steel and iron alloys, composite materials, titanium, brass, copper, and the like; a drive stud 72 approximately—for example and not as a limitation—⅜ inch; a standard or metric socket 75 matched to accept/reattach ably connected and surrounding a drive stud 72 approximately—for example and not as a limitation—⅜ inch; a bearing Snap-On component 81 with clip 81A on the inside to prevent removal; a skate base plate 82; a bearing/bushing 83 of wheel 88; a bearing/bushing 84 of torsion arm 70; a center post 85; an offset post 86; a support post 87; a wheel 88 made of plastics, reinforced plastics, ceramics, metals and the like; an auxiliary wheel 80A and having a cross section like a regular-shaped; a stub shaft/wheel axel or same 89 of wheel 88; a hub base 90; a cover 99 over system 30 components and removably attached to skate base plate 82 of the skate 80; a floor level 105; an adjustable brake pad 110; and a gripper pad 115 for soft mode.

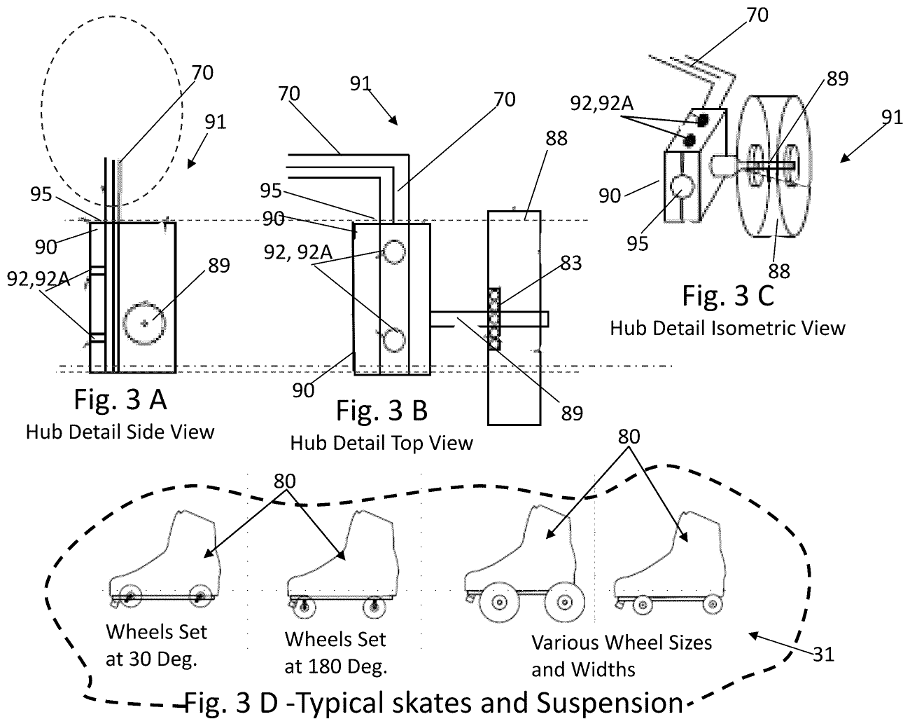

FIGS. 3 A through 3 D are sketches of the hub detail 91 from various views with the components and features shown and a set of typical skates 90 that can benefit from the low-profile suspension system 30 from generally a side view. Portrayed are components and features as follows: a torsion arm 70 with various cross-sections 70A—and said torsion arm made of various materials 70B—steel, steel and iron alloys, composite materials, titanium, brass, copper, and the like; a skate shoes 80—various sets and types 80A—cambers and various sizes shown, as example only and not as a limitation; a bearing Snap-on component 81 with clip 81A on the inside to prevent removal; a skate base plate 82; a bearing/bushing 83 of wheel 88; a bearing/bushing 84 of torsion arm 70; a wheel 88 made of plastics, reinforced plastics, ceramics, metals and the like; an auxiliary wheel 80A and having a cross section like a regular-shaped; a stub shaft/wheel axel or same 89 of wheel 88; a hub base 90; a sketch 91 of hub base components; a set of screws 92 on hub base 90; a set screws 92 on hub base 90; a set of apertures 92A for removably connecting set screws 92 through the hub base 90 to torsion arm 70; and a series of apertures 95 through posts 85,86, and/or 87 and through hub base 90 for securing torsion arm 70 to the hub base 90 by means of at least one set screws 92 removably secured in the apertures 92A of the hub base 90.

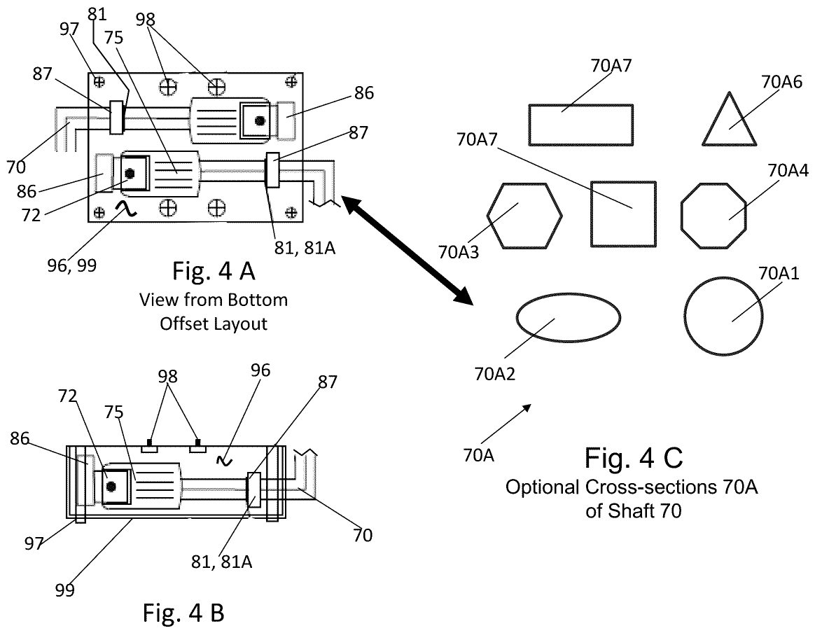

FIGS. 4 A through 4 C are sketches of the Offset type of suspension 35 from a bottom and a rear view with components and features noted and example cross sections 70A for the shaft 70. Demonstrated in these drawings are: a torsion arm 70 with various cross-sections 70A—and said torsion arm made of various materials 70B—steel, steel and iron alloys, composite materials, titanium, brass, copper, and the like; a cross section 70A of the shaft 70 such as a circle 70A1, ellipse 70A2, hexagon 70A3, octagon 70A4, square 70A5, triangle 70A6, rectangle 70A7, and regular and irregular polygons; a drive stud 72 approximately—for example and not as a limitation—⅜ inch; a standard or metric socket 75 matched to accept/re-attach ably connected and surrounding a drive stud 72 approximately—for example and not as a limitation—⅜ inch; a bearing Snap-on component 81 with clip 81A on the inside to prevent removal; a skate base plate 82; a bearing/bushing 83 of wheel 88; a bearing/bushing 84 of torsion arm 70; a center post 85; an offset post 86; a support post 87; a wheel 88 made of plastics, reinforced plastics, ceramics, metals and the like; an auxiliary wheel 80A and having a cross section like a regular-shaped; a stub shaft/wheel axel or same 89 of wheel 88; a hub base 90; a set of screws 92 on hub base 90; a set screws 92 on hub base 90; a set of apertures 92A for removably connecting set screws 92 through the hub base 90 to torsion arm 70; a series of apertures 95 through posts 85,86, and/or 87 and through hub base 90 for securing torsion arm 70 to the hub base 90 by means of at least one set screws 92 removably secured in the apertures 92A of the hub base 90; a flat plate 96 contiguous to a cover 99 with at least two support posts 85, 86, 87 secured essentially perpendicular to flat plate 96 (welded, molded, cast or equal posts to plate 99A) and apertures for set screws 97 and 98; a set of screws 96 A through apertures of flat plate 96 to secure a flat plate 96 to skate base 82; a means 97 for removably connecting cover 99 to skate base plate 82 such as screws, bolts, rivets, pins and the like; a means 98 for removably connecting flat plate 96 of suspension system 30 to skate base plate 82 such as screws, bolts, rivets, pins, bobby pins, and the like; a cover 99 over system 30 components and removably attached to skate base plate 82 of the skate 80; a gripper pad 115 for soft mode; a cross-section 120; and a type of material 123 for the low profile, high strength suspension system 30.

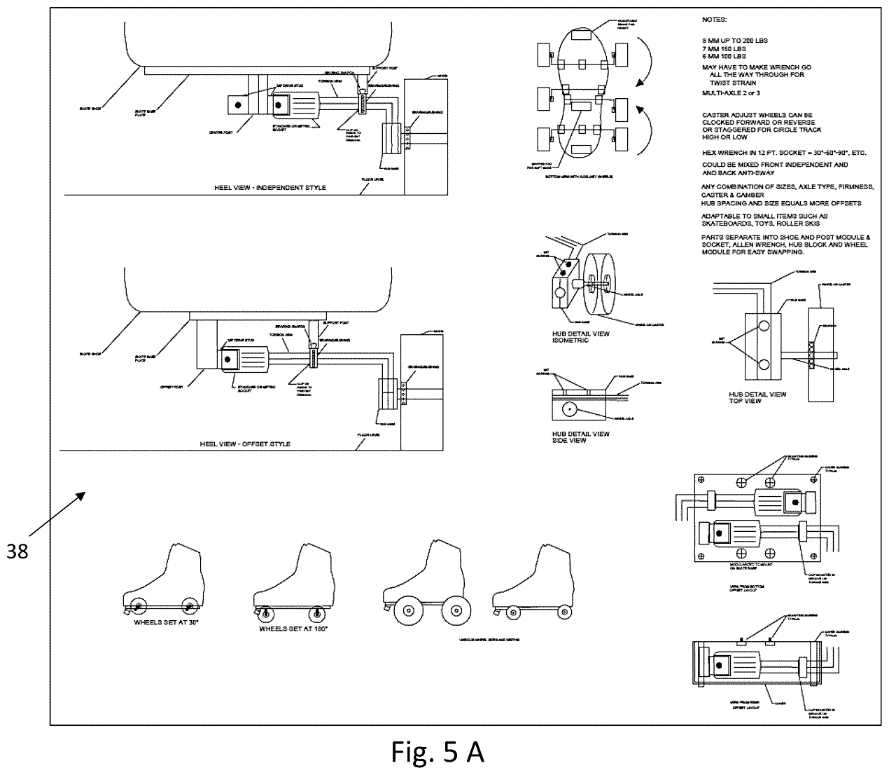

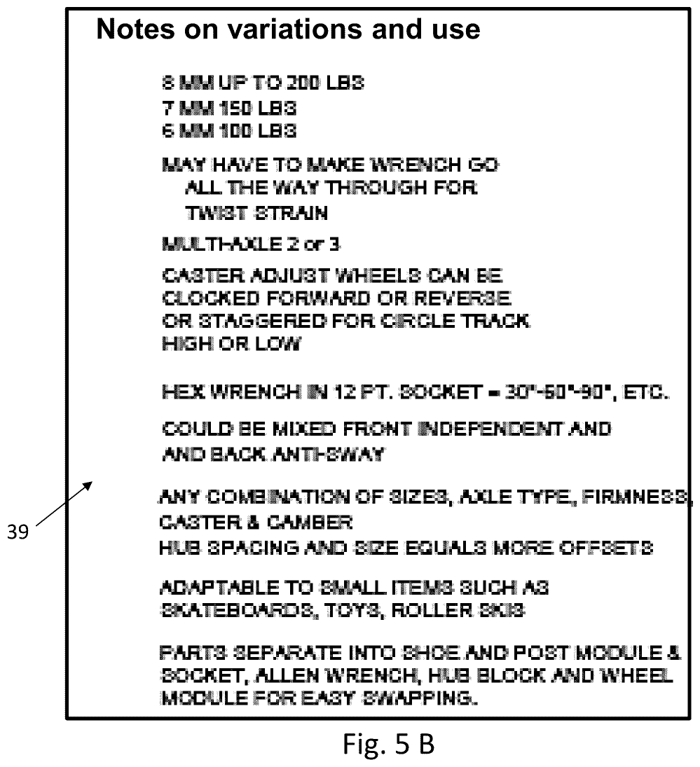

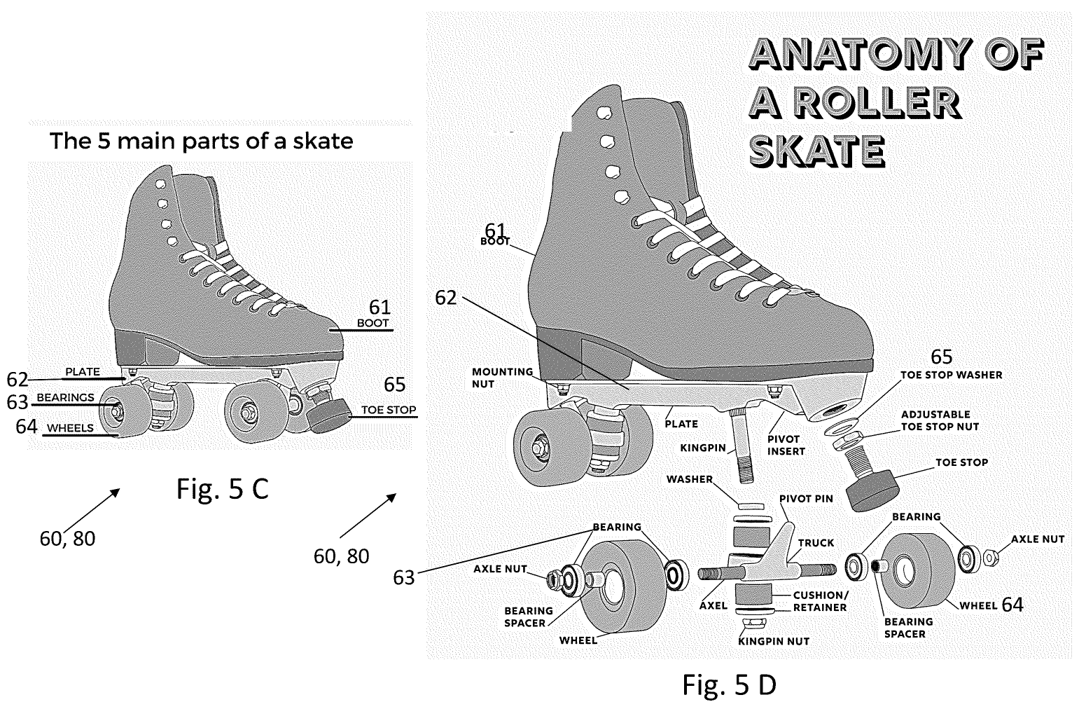

FIGS. 5 A through 5 D are drawings for the low profile, high strength suspension system 30 with optional variations for the system 30 and a typical roller skate 60, 80 and components. Shown in these drawings are a low profile, high strength suspension system 30; an independent style suspension 32; a set of manufacturing drawings 38 for low profile, high strength suspension system 30; and a set of notes 39 on variations and uses. In view of FIGS. 5 C and 5 D of the drawings of typical skates 60,80, one sees: a boot 61. Every skate has a boot 61: the boot uppers (the part of the boot above the sole) can be made of leather, suede, or man-made materials such as acrylic. The inside of boot 61 is called the “lining” and is padded for comfort. Other parts of the boot include the sole, tongue, eyelets and/or hooks, laces, and sometimes a Velcro speed strap for added security in addition to laces. Boots are either high-top (artistic skating) or low-top (speed skating). Plate 62: plate 62 is mounted to the bottom of the boot and is what everything else (all other components) is attached to. Plates are typically metal (aluminum, magnesium, etc.) or nylon. Metal plates are more durable, while nylon plates tend to be lighter weight. Attached to the plate are the trucks, axle, kingpin, cushions (1) cushion makes it a “single action” plate, and two (2) cushions make it a “double action” plate), and in some cases an added jump bar. Bearings 63—Bearings 63 are located inside the wheel hub and help the wheels spin. Each wheel has two (2) bearings in it, so a pair of skates uses sixteen (16) bearings total. They come in two sizes, 7 mm and 8 mm. Bearings need to be kept clean to ensure they continue spinning freely and last as long as possible before needing to be replaced. Wheels 64—Skate wheels 64 come in different sizes and in different hardness rating levels that vary based on one's style of skating. Outdoor wheels are softer than indoor wheels. The larger the wheel, the greater the traction. The smaller the wheel, the more agility the wheel offers. Toe Stops or Jam Plugs 65—Toe stops 65 are either adjustable or fixed (non-adjustable) and helps one skater to slow down his/her own skates. Jam plugs are an alternative to toe stops when the style of skating does not require a toe stop, such as jam skating. Inline skates have a brake at the end of one boot as opposed to in the front of both boots. FIGS. 5 C and 5 D are drawings discussed in the operation section below.

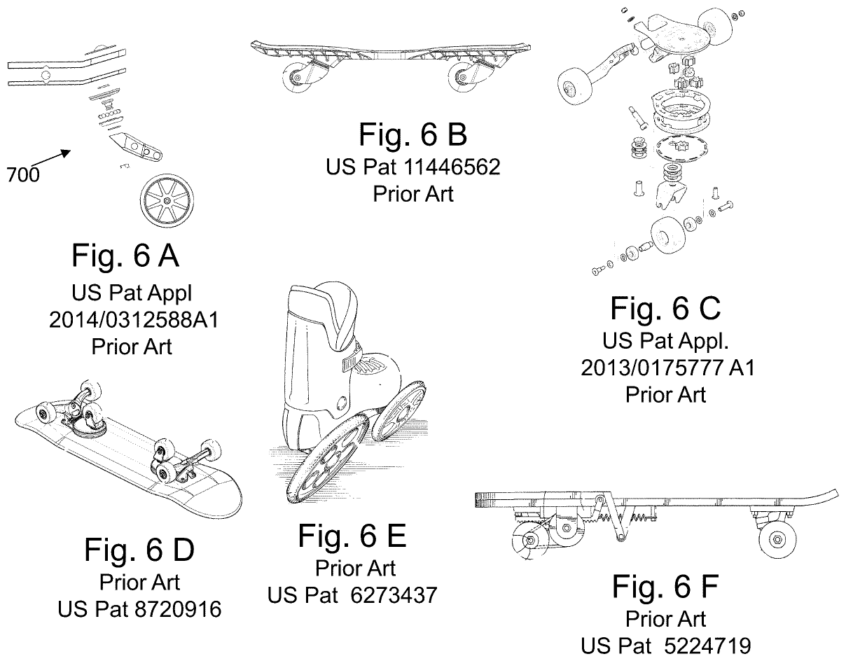

FIGS. 6 A through 6 F are sketches of prior art skates, boards, and suspension systems for comparison with the Applicants' device. These include: a prior art 700 US patent application US20140312588 by Davis in 2014 for Swivel Wheel Mounting for a Scooter; a prior art 710 U.S. Pat. No. 11,446,562 by Desberg in 2022 for Caster Boards with Removable Insert; a prior Art 720 US patent application US20130175777 by Bermal in 2013 for Skateboard Truck; a prior Art 730 U.S. Pat. No. 8,720,916 by Bermal in 2014 for Skateboard Truck; a prior Art 740 U.S. Pat. No. 6,273,437 by Lovitt et al., in 2001 for Roller Skate; and a prior Art 750 US patent application U.S. Pat. No. 5,224,719 by Bryon L. Goodspeed in 1993 for Skateboard. As can be seen, the low-profile suspension device 30 for skates, skateboards, and the like is a unique suspension device with the advantages shown above.

The materials and components shown for the low-profile suspension device 30 for skates, skateboards, and the like are made of safe and durable materials. The torsion shaft 70 will be made of materials that are durable and high strength for this low-profile device. These anticipated materials, for example and not as a limitation, include steel, steel and iron alloys, composite materials, titanium, brass, copper, and the like. The wheels anticipate typical materials such as plastics, reinforced plastics, ceramics, metals and the like. These are shown for example and not to limit the new, low-profile suspension device. Plastics will need to be flexible and rigid, such as Polyethylene (ULDPE, LDPE, MDPE, HDPE), Polypropylene (homopolymer and copolymer), Polystyrene, Thermoplastic Elastomers (TPE's), Thermoplastic Polyurethane (TPU's)—Polyurethanes, Polycarbonate, and Nylon. Stainless steel or equal are used as well for some components.

The various details mentioned throughout this description of the low-profile suspension system for skates, skateboards, and the like are exemplary and not limiting. Other specific components and manners specific to describing a low-profile suspension device 30 for skates, skateboards, and the like can be added as a person having ordinary skill in the field of the art of components and devices.

### OPERATION OF THE PREFERRED EMBODIMENT

The preferred embodiment of the low-profile suspension device 30 for skates, skateboards, and the like is: a low profile, high strength suspension system or device 30 to support a typical roller skate 60 comprising (a) at least one independent style suspension 32 and/or an offset style suspension 35 wherein the suspension system 30 comprises: (1) a flat plate 96 contiguous to a cover 99 with apertures 97A; (2) at least two support posts center 85, offset post 86, and/or support post 87, each post being fixedly secured at a flat plate end and configured essentially perpendicular to the flat plate 96 and each post with either a drive stud 72 at one end and an aperture 95 and bearing at an end opposite the flat plate 96 and the drive stud 72; (3) torsion arm 70 with a standard or metric socket 75 at one end to removably connect to the drive stud 72; and (4) a hub base 90 with at least one apertures 95 to encircle the torsion arm 70 at the end opposite the socket 75 and set screws to secure the hub base to the torsion arm 70, and the hub base 90 removably secured to a stub shaft 89; and (b) a means 98 to attach the flat plate 96 of the low profile, high strength suspension system 30 to a skate base plate 82 of the typical roller skate 50; (c) the cover 99 with apertures 97A; and (d) a means 97 for removably connecting cover 99 to skate base plate 82.

FIGS. 5 C and 5 D are drawings FIG. 11 are sketches of the Process 600 for Non-kink IV 30 shown with option four type Silent antecubital or Silent AC with an inflatable bladder 99 or soft rubber ball with a stretchy netting 66 and with the components and features noted. The method and/process 600 used to install the/a low-profile suspension device 30 for skates, skateboards, and the like.

FIGS. 5 C and 5 D are drawings for the low profile, high strength suspension system 30 with optional variations 39 for the device 30 and a typical roller skate 60, 80 with components. These variations include: a width variation for the wheels 88—8 MM width supports up to 200 pounds each, 7 MM width up to 150 Pounds, and 6 MM width up to 100 Pounds; The device 30 may be advantaged with an optional and special wrench that extends all the way through the hubs 90 for twist strain; the caster adjust wheels can be clocked forward or reverse or staggered for a circular track with high or low banking (slope built into the track configuration to enhance the user of the roller skates or skateboards to achieve higher speeds); utilizing a hex wrench in twelve (12} point socket—thirty (30°) degrees, (60°) degrees, (90°) ninety degrees, etc.; mixing the type of wheels and suspension set on the skate or skateboard—for example, a user could be mixed wheels and suspension like a front independent set and back anti-sway suspension to balance the slopes; one notes that the aftermarket devices can be re-vamped or new skates of skateboards can have many different combination of sizes, axel type, firmness, caster and camber; further, the hub spacing and size equals more offset suspension options; and one notes that the low suspension concept for skates and skateboard can be adapted to small items such as skates, skateboards, roller skis, toys, moving carts and other wheeled devices. For the roller skates using this low-profile suspension mechanisms can have component parts separated, for example, into a shoe module and post module, and a socket module with the hub, Allen wrench, hub block, and wheel. With these modules, one is permitted to make easy and fast swapping of modules during sporting and competitive timed events.

Many uses are anticipated for the low-profile suspension device for skates, skateboards, and the like. Some examples, and not limitations, are shown in the following Use Table.

| ITEM | DESCRIPTION |
|---|---|
| 1 | Indoor skates |
| 2 | Outdoor skates |
| 3 | Skateboards |
| 4 | Roller-type skis |
| 5 | Auxiliary roll-a-round carts for moving |
| | furniture and appliances where a low-profile |
| | suspension of the caster and wheels is critical |
| 6 | the low-profile suspension device 30 for |
| | skates, skateboards, and the like can be |
| | implemented with new roller skates and |
| | skateboards (original equipment/OE) or |
| | implemented as an add-on to existing roller |
| | skates and/or skateboards (an aftermarket/AM |
| | device) |

With this description it is to be understood that the low-profile suspension device 30 for skates, skateboards, and the like is not to be limited to only the disclosed embodiment of product. The features of the present improved low-profile device 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of a presently preferred embodiment of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted as coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications and equivalents that come within the spirit of the disclosures described heretofore and or/defined by the following claims are desired to be protected.

What is claimed is:

1. A low profile, high strength suspension system (30) to support a typical roller skate (60) comprising:
(a) at least one independent style suspension (32) and/or an offset style suspension (35) wherein the suspension system (30) comprises:
(1) a flat plate (96) contiguous to a cover (99) with apertures (97A).
(2) at least two support posts center (85), offset post (86), and/or support post (87), each post being fixedly secured at a flat plate end and configured essentially perpendicular to the flat plate (96) and each post with either a drive stud (72) at one end and an aperture (95) and bearing at an end opposite the flat plate (96) and the drive stud (72);
(3) torsion arm (70) with a standard or metric socket (75) at one end to removably connect to the drive stud (72); and
(4) a hub base (90) with at least one aperture (95) to encircle the torsion arm (70) at the end opposite the socket (75) and set screws to secure the hub base to the torsion arm (70), and the hub base (90) removably secured to a stub shaft (89); and
(b) a means (98) for attaching a flat plate (96) of the low profile, high strength suspension system (30) to a skate base plate (82) of the typical roller skate (50);
(c) the cover (99) with apertures (97A); and
(d) a means (97) for removably connecting cover (99) to skate base plate (82)
wherein the low profile, high strength suspension system (30) to support a typical roller skate (60) has several uses.

2. The low profile, high strength suspension system (30) as described in claim 1 wherein the torsion arm (70) is made of durable and high strength materials.

3. The low profile, high strength suspension system (30) as described in claim 2 wherein the durable and high strength materials is selected from the group consisting of steel, steel and iron alloys, composite materials, titanium, brass, and copper

4. The low profile, high strength suspension system (30) as described in claim 1 wherein the torsion arm (70) is configured in a specific cross section (70A).

5. The low profile, high strength suspension system (30) as described in claim 4 wherein the specific cross section (70A) of the torsion arm (70) is selected from the group consisting of a circle 70A1), an ellipse (70A2), a hexagon (70A3), an octagon (70A4), a square (70A5), a triangle (70A6), a rectangle (70A7), a regular polygon, and an irregular polygons.

6. The low profile, high strength suspension system (30) as described in claim 1 wherein the type of configuration of the socket is selected from the group consisting of a standard socket and a metric socket.

7. The low profile, high strength suspension system (30) as described in claim 1 wherein the several uses is selected from the group consisting of Indoor skates, Outdoor skates, Skateboards, Roller-type skis, Auxiliary roll-a-round carts for moving furniture and appliances, original equipment/new skates, add-on, aftermarket skates, original equipment/new skateboards, and add-on, aftermarket skateboards.

8. The low profile, high strength suspension system (30) as described in claim 1 wherein the means (98) for attaching a flat plate (96) to a skate base plate (82) is selected from the group consisting of screws, bolts, rivets, and pins.

9. The low profile, high strength suspension system (30) as described in claim 1 wherein the means (97) for removably connecting the cover (99) is selected from the group consisting of screws, bolts, rivets, and pins.

10. A low profile, high strength suspension system (30) to support a typical roller skate (60) comprising:
(a) at least one independent style suspension (32) and/or an offset style suspension (35) wherein the suspension system (30) comprises:
(1) a flat plate (96) contiguous to a cover (99) with apertures (97A);
(2) at least two support posts center (85), offset post (86), and/or support post (87), each post being fixedly secured at a flat plate end and configured essentially perpendicular to the flat plate (96) and each post with either a drive stud (72) at one end and an aperture (95) and bearing at an end opposite the flat plate (96) and the drive stud (72);
(3) torsion arm (70) made of a steel alloy and configured as an ellipse (70A2) with a standard socket (75) at one end to removably connect to the drive stud (72); and
(4) a hub base (90) with at least one aperture (95) to encircle the torsion arm (70) at the end opposite the socket (75) and set screws to secure the hub base to the torsion arm (70), and the hub base (90) removably secured to a stub shaft (89); and
(b) a means (98) for attaching a flat plate (96) of the low profile, high strength suspension system (30) to a skate base plate (82) of the typical roller skate (50);
(c) the cover (99) with apertures (97A); and
(d) a means (97) for removably connecting cover (99) to skate base plate (82)
wherein the low profile, high strength suspension system (30) to support a typical roller skate (60) has several uses.

11. The low profile, high strength suspension system (30) as described in claim 10 wherein the torsion arm (70) is configured in a specific cross section.

12. The low profile, high strength suspension system (30) as described in claim 11 wherein the specific cross section (70A) of the torsion arm (70) is selected from the group consisting of a circle 70A1), an ellipse (70A2), a hexagon (70A3), an octagon (70A4), a square (70A5), a triangle (70A6), a rectangle (70A7), a regular polygon, and an irregular polygons.

13. The low profile, high strength suspension system (30) as described in claim 10 wherein the several uses is selected from the group consisting of Indoor skates, Outdoor skates, Skateboards, Roller-type skis, Auxiliary roll-a-round carts for moving furniture and appliances, original equipment/new skates, add-on, aftermarket skates, original equipment/new skateboards, and add-on, aftermarket skateboards.

14. The low profile, high strength suspension system (30) as described in claim 10 wherein the means (98) for attaching a flat plate (96) to a skate base plate (82) is selected from the group consisting of screws, bolts, rivets, and pins.

15. The low profile, high strength suspension system (30) as described in claim 10 wherein the means (97) for removably connecting the cover (99) is selected from the group consisting of screws, bolts, rivets, and pins.
